(19) United States
(12) Patent Application Publication
(10) Pub. No.: US 2021/0153299 A1
(43) Pub. Date: May 20, 2021

(54) HEATER POWER DELIVERY

(71) Applicant: Hewlett-Packard Development Company, L.P., Spring, TX (US)

(72) Inventors: Robert Yraceburu, Vancouver, WA (US); Duane A Koehler, Vancouver, WA (US); Francisco Alcazar, Vancouver, WA (US)

(21) Appl. No.: 17/048,345

(22) PCT Filed: Aug. 21, 2018
(86) PCT No.: PCT/US2018/047146

§ 371 Date: Oct. 16, 2020

(51) Int. Cl. H05B 1/02; H02M 1/088; B41J 11/00; G05B 19/042

(52) U.S. Cl. CPC H05B 1/0241; H02M 1/088; B41J 11/00212; G05B 2219/25257; G05B 19/042; H05B 2203/005; G05B 2219/25252; B41J 11/00222

(57) ABSTRACT

In some examples, a system includes a first heater and a second heater, and a controller to receive a power request indicating a power level for the second heater, in response to the power request, select a power delivery technique from among different power delivery techniques that employ different ways of delivering power to the first and second heaters, and cause powering of the first and second heaters using the selected power delivery technique.

### BACKGROUND

A printing system is used to form an image (including text and/or graphics) on a print medium. In some examples, to form an image on a print medium, the printing system can dispense printing fluids (e.g., inks) onto the print medium at selected locations. Heaters can be provided in a printing system to apply heat to a print medium to condition the print medium.

### BRIEF DESCRIPTION OF THE DRAWINGS

Some implementations of the present disclosure are described with respect to the following figures.

FIG. 1 is a block diagram of a system, according to some examples.

FIG. 2 is a block diagram of a printing system, according to some examples.

FIGS. 3A-3D show different power delivery techniques selectable by a controller according to some examples.

FIG. 4 is a block diagram of a storage medium storing machine-readable instructions according to some examples.

FIG. 5 is a flow diagram of a process of a system according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Various types of heaters can be used in a printing system to condition a print medium. In some examples, after forming an image on a print medium, such as by applying printing fluids (e.g., inks of a particular color or multiple colors) onto the print medium, a heater (or alternatively, multiple heaters) can be activated to condition the print medium. As used here, a “heater” can refer to any energy source that when activated produces heat energy to raise the temperature of a target, which in some examples includes a print medium, and in other examples includes a different target.

Although reference is made in the present discussion to printing systems, it is noted that techniques or mechanisms according to some implementations of the present disclosure can be applied to other types of systems that include heaters.

A heater can be associated with a control mechanism to control the amount of heat applied by the heater. For example, the control mechanism can include a servo device that uses error-sensing negative feedback to correct the action of the heater. The servo device receives a temperature setpoint, which is a target temperature to be applied by the heater. A temperature sensor can be used to detect the actual temperature applied by the heater, such as the actual temperature of the print medium or a region near the print medium. The temperature measurement from the temperature sensor can be used to produce an error-correction indication that provides feedback to the servo device to allow the servo device to adjust, based on the feedback and the temperature setpoint, the power level provided to the heater (by either increasing or decreasing the power level provided to the heater). In some examples, the adjustment of the power level provided to the heater can be based on use of pulse width modulation (PWM) that controls a duty cycle of activation of the heater. The duty cycle of heater activation describes a proportion of the amount of time that the heater is on with respect to the amount of time that the heater can be on during a specified time duration (i.e., the time duration of a “power cycle”).

During certain phases of operation of a printing system, the heaters of the printing system can consume a relatively high amount of dynamic power from a power source, such as an alternating current (AC) power line to which the printing system is connected.

If there is an insufficient amount of power delivered to a heater, then a temperature sag can occur for the heater, which can result in the heater not heating a target to a target temperature. As an example, a temperature sag can cause a print medium to not be heated to a target temperature, which can cause any or some of the following effects: printing fluids formed on the print medium are not dried sufficiently, warping of the print medium may occur, and so forth.

The printing system may be able to deliver a finite amount of power at any given time, which if not managed properly can lead to one of multiple heaters in the printing system not receiving a sufficient amount of power under certain conditions. For example, if a first servo device requests a PWM duty cycle of 80% for a first heater (the first heater is activated 80% of a specified time interval and off the remaining 20% of the specified time interval), and a second servo device requests a PWM duty cycle of 70% for a second heater, a printing system may not have sufficient power to satisfy the PWM duty cycles requested by both for the first and second servo devices. More generally, there can be multiple servo devices that can request multiple respective PWM duty cycles (or more generally, respective power levels) for corresponding different heaters of the printing system.

Additionally, the dynamic power loads that include the heaters of a printing system are managed to meet regulatory restrictions for power line flicker. Power line flicker refers to changes in current drawn from the power line over time. High rates of large changes in current drawn from the power line can increase power line flicker. If the heaters cause the current drawn to vary widely in a short amount of time, then the printing system may violate the regulatory restrictions for power line flicker.

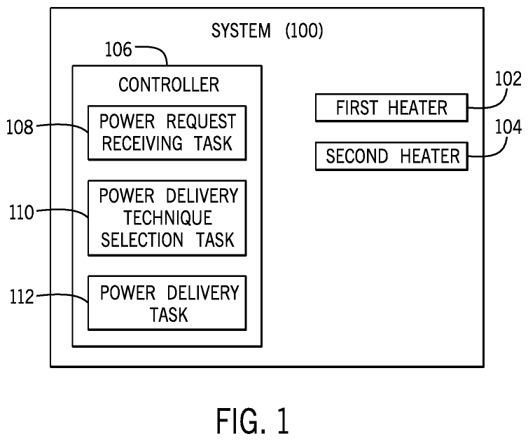

In accordance with some implementations of the present disclosure, as shown in FIG. 1, a system 100 (which can be a printing system or any other type of system) includes a first heater 102 and a second heater 104. The first and second heaters 102 and 104 can be different types of heaters. For example, the first heater 102 can include a radiant heater (e.g., an infrared lamp or other energy source that produces heat that is radiantly propagated to a target such as a print medium or a different target). As further examples, the second heater 104 can include a dryer, which produces a flow of heated air or other type of gas towards a target such as a print medium. Although specific examples of heaters are discussed, it is noted that in other examples, other types of heaters can be employed in the system 100. Moreover, although just two heaters are shown in FIG. 1, it is noted that the system 100 can include more than two heaters in other examples. For example, the system 100 can include multiple heaters of a first type (e.g., multiple radiant heaters) and/or multiple heaters of a second type (e.g., multiple dryers). Additionally, the system 100 can include other types of heaters in other examples.

The system 100 further includes a controller 106 that can perform various control tasks with respect to the first and second heaters 102 and 104.

As used here, a “controller” can refer to a hardware processing circuit, which can include any or some combination of a microprocessor, a core of a multi-core microprocessor, a microcontroller, a programmable integrated circuit, a programmable gate array, or another hardware processing circuit. Alternatively, a “controller” can refer to a combination of a hardware processing circuit and machine-readable instructions (software and/or firmware) executable on the hardware processing circuit.

The tasks performed by the controller 106 can include a power request receiving task 108 that receives power requests indicating power levels for the first heater 102 and the second heater 104. For example, a power request can include a request from a servo device or other type of control mechanism that controls power to the respective heater 102 or 104. A “request” can refer to a signal, a message, an information element, or any other indication of a power level that is being requested for the respective heater 102 or 104.

The tasks of the controller 106 further include a power delivery technique selection task 110 that, in response to the power requests indicating the power levels for the first and second heaters 102 and 104, selects a power delivery technique from among different power delivery techniques that employ different ways of delivering power to the first and second heaters 102 and 104.

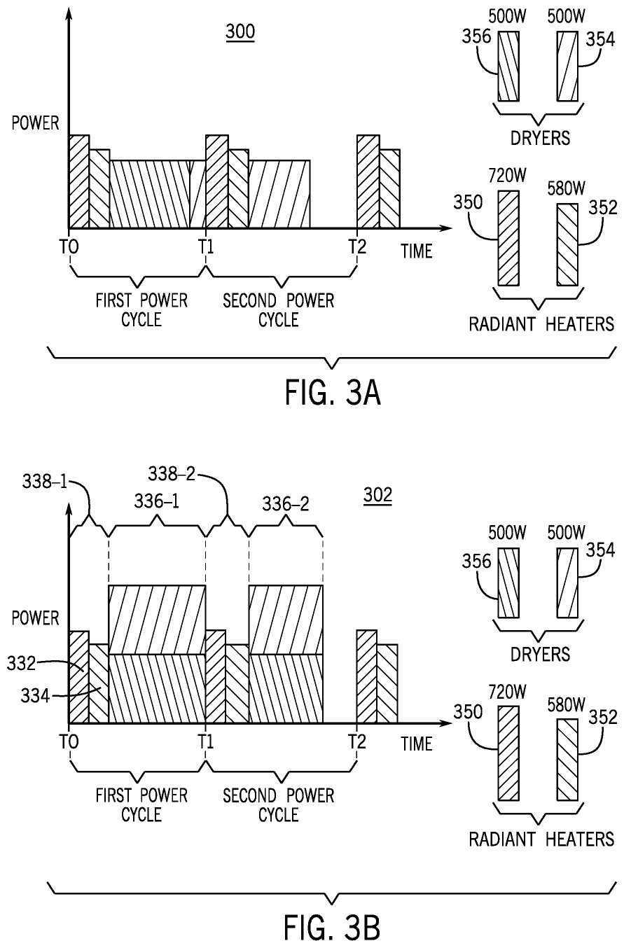

Examples of the different power delivery techniques are discussed in further detail in connection with FIGS. 3A-3D.

The selection of the power delivery technique from among the different power delivery techniques is based on the determination of which of the power delivery techniques are able to supply the power level indicated by the power request for the second heater 104, given a power level to be delivered to the first heater 102 in response to the power request for the first heater 102.

More specifically, the controller 106 is to determine, within a power cycle, an available deliverable power by a given power delivery technique based on subtracting the power level to be used by the first heater 102 (or multiple first heaters 102) from a maximum deliverable power to heaters, and where the controller 106 is to determine if the given power delivery technique is able to supply the power level indicated by the power request for the second heater 104 (or multiple second heaters 104) based on the available deliverable power.

Examples of the different power delivery techniques include a first power delivery technique that allows simultaneous activation of the first heater of a first type and the second heater of a second type and also allows simultaneous activation of multiple second heaters of the second type (FIG. 3C discussed further below), a second power delivery technique that disallows simultaneous activation of the first heater of the first type and the second heater of the second type but allows simultaneous activation of the multiple heaters of the second type (FIG. 3B discussed further below), and a third delivery technique that disallows simultaneous activation of the multiple heaters of the second type (FIG. 3A discussed further below).

The tasks of the controller 106 further include a power delivery task 112 to cause powering of the first and second heaters 102 and 104 using the selected power delivery technique.

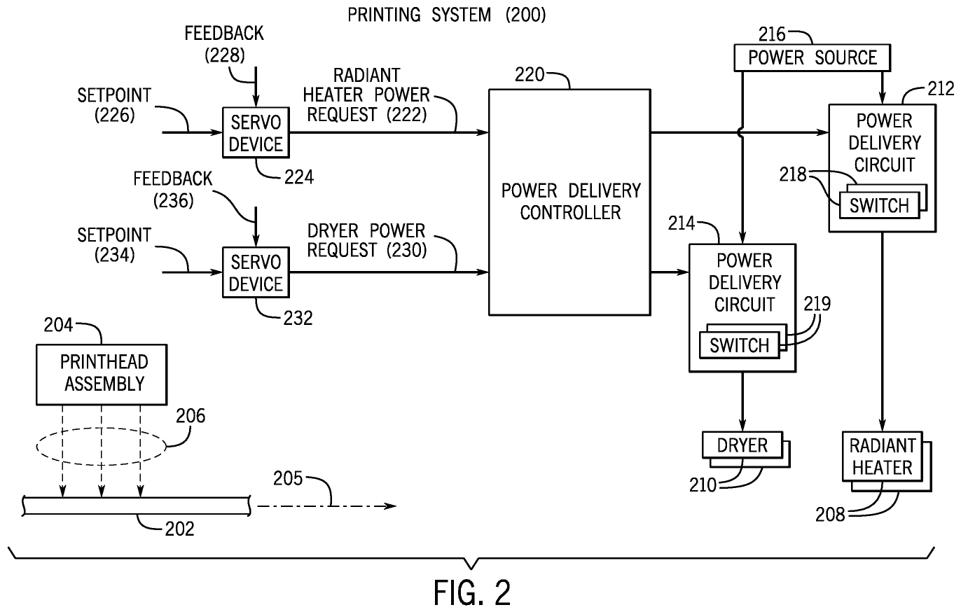

FIG. 2 is a block diagram of an example printing system 200 that includes various components to form an image on a print medium 202 and to condition the print medium 202. Examples of the print medium 202 can include a paper substrate, a plastic substrate, a cloth substrate, or another type of substrate onto which an image (including text and/or graphics) can be formed.

The printing system 200 includes a printhead assembly 204 that can deliver printing fluids 206 onto a surface of the print medium 202. For example, the printhead assembly 204 can include printheads for delivering inks of different colors onto the print medium 202. During a printing operation, the print medium 202 is moveable relative to the printhead assembly 204 in a direction indicated by the arrow 205.

The printing system 200 further includes radiant heaters 208 and dryers 210 for heating the print medium 202 and for conditioning the print medium 202. The print medium 202 can be moved to locations proximate the radiant heaters 208 and the dryers 210.

Although FIG. 2 shows two dryers 210 and two radiant heaters 208, it is noted that in other examples, a different number (one or greater than two) of dryers and/or a different number (one or greater than two) of radiant heaters may be employed.

The print medium 202 can be heated by the radiant heaters 208 and the dryers 210 after forming an image onto the print medium 202 by the printhead assembly 204. In other examples, one of the radiant heaters 208 and dryers 210 can apply heating onto the print medium 202 prior to printing by the printhead assembly 204.

The radiant heaters 208 are associated with a radiant heater power delivery circuit 212, and the dryers 210 are associated with a dryer power delivery circuit 214. A “power delivery circuit” can refer to circuitry that provides an amount of power from a power source 216 to a respective heater (or respective heaters). The power source 216 can include an AC power line, a battery, a solar panel, or any other type of power source.

In some examples, the radiant heater power delivery circuit 212 includes controllable electrical current switches 218 through which electrical current from the power source 216 can flow to respective radiant heaters 208. The dryer power delivery circuit 214 similarly includes electrical current switches 219 through which electrical current flows from the power source 216 to the dryers 210.

In some examples, each electrical current switch 218 or 219 can be implemented as a triode for alternating current (TRIAC). Alternatively, each electrical current switch 218 or 219 can be implemented as a relay or another type of device that are controllable between on and off states to selectively pass electrical current between the power source 216 and a corresponding heater (208 or 210).

The electrical switches 218 and 219 are controlled by a power delivery controller 220. The power delivery controller 220 can select a power delivery technique from among multiple different power delivery techniques for application of the power to the radiant heaters 208 and the dryers 210. In some examples, the power delivery controller 220 can include machine-readable instructions (e.g., firmware and/or software) executable on a hardware processing circuit. Although not shown, the power delivery technique controller 220 can also include a control device (e.g., a microcontroller, a programmable gate array, a programmable integrated circuit device, etc.) that controls the electrical switches 218 and 219 based on the power delivery technique selected by the power delivery controller 220.

The power delivery controller 220 receives a radiant heater power request 222 from a servo device 224 associated with the radiant heaters 208. The radiant heater power request 222 can specify a power level for the radiant heaters 208, where the power level can include a PWM duty cycle in some examples. Although FIG. 2 shows an example in which one radiant heater power request 222 specifies the power level for the multiple radiant heaters 208, in other examples, multiple radiant heater power requests 222 can specify respective power levels (e.g., PWM duty cycles) for the respective multiple radiant heaters 208.

The servo device 224 receives a setpoint 226, which can be a temperature setpoint that specifies a target temperature to be applied by the radiant heaters 208 to a target (e.g., the print medium 202 or a region near the print medium 202). In addition, the servo device 224 receives a feedback 228, which can include an error control indication based on a temperature measured by a temperature sensor (or multiple temperature sensors). The measured temperature is a temperature of the print medium 202 or of a region near the print medium 202.

Based on the setpoint 226 and the feedback 228, the servo device 224 determines the power level to be requested for the radiant heaters 208, where the power level can be in the form of a PWM duty cycle in some examples. The servo device 224 issues the radiant heater power request 222 to request this power level.

The power delivery controller 220 further receives a dryer power request 230 from a servo device 232 associated with the dryers 210. Although FIG. 2 shows an example in which one dryer power request 230 specifies the power level for the multiple dyers 210, in other examples, multiple dryer power requests 230 can specify respective power levels (e.g., PWM duty cycles) for the respective multiple dryers 210.

The servo device 232 receives a setpoint 234, such as a temperature setpoint that specifies a target temperature to be applied by the dryers 210. In addition, the servo device 232 receives a feedback 236, which can include an error control indication based on a temperature measurement (or temperature measurements) from a temperature sensor (or temperature sensors) that measures a temperature applied by the dryers 210.

Based on the setpoint 234 and the feedback 236, the servo device 232 determines the power level to be requested for the dryers 210, which can be in the form of a PWM duty cycle in some examples. The servo device 232 issues the dryer power request 230 to request this power level.

FIGS. 3A-3D depict four different power delivery techniques 300, 302, 304, and 306 according to some examples. Although specific power delivery techniques are shown, it is noted that different power delivery techniques can be used in other examples.

In the examples described in connection with FIGS. 3A-3D, it is assumed that the radiant heaters 208 are assigned a higher priority for power delivery over the dryers 210 when granting requests to provide power to the radiant heaters 208 and the dryers 210. In other words, given competing requests for power for the radiant heaters 208 and the dryers 210 that would cause a maximum amount of available power from the system to be exceeded if both requests are to be fully satisfied, the radiant heaters 208 can be granted as much power as requested for the radiant heaters 208, and the dryers 210 can be provided with the remaining available power. In alternative examples, the dryers 210 can be assigned a higher priority for power delivery over the radiant heaters 208.

The power delivery technique 306 of FIG. 3D can be used when a system, such as the system 100 of FIG. 1 or the printing system 200 of FIG. 2, is initializing or in any other state where the heaters of the system are relatively cool and have not produced enough heat yet such that the heaters or heated system have reached a target temperature. The heating up phase of the heaters can be referred to as an “initialization phase” of the heaters.

In a specific example discussed in connection with FIGS. 3A-3D, it is assumed that each of the dryers 210 is a 500-watt (500 W) dryer that each can consume 500 watts of power when activated. In this example, it is assumed that one of the radiant heaters 208 is a 720 W radiant heater, and the other radiant heater is a 580 W radiant heater. In other examples, the dryers 210 and radiant heaters 208 can consume different amounts of power when activated.

FIG. 3D shows blocks that represent when the radiant heaters 208 and dryers 210 are activated. The horizontal axis in FIG. 3D depicts time, and the vertical axis depicts power. Different blocks with different fill patterns are used to indicate which of the radiant heaters 208 and dryers 210 are activated at a given time.

A block with fill pattern 350 represents the 720 W radiant heater (hereinafter the “first radiant heater”), a block with fill pattern 352 represents the 580 W radiant heater (hereinafter the “second radiant heater”), a block with fill pattern 354 represents the first dryer of the 500 W dryers, and a block with fill pattern 356 represents the second dryer of the 500 W dryers.

A time duration between time T0 and time T1 corresponds to a first power cycle, and the time interval between time T1 and time T2 corresponds to a second power cycle. As depicted in FIG. 3D, in a first half of the first power cycle between T0 and T1, the first radiant heater is activated (as represented by block 310) concurrently with the first dryer (as represented by block 308). In the second half of the first power cycle between T0 and T1, the second radiant heater is activated (as represented by block 314) concurrently with the second dryer (as represented by block 312). Concurrent activations of pairs of a dryer and a radiant heater can similarly be performed in each respective portion of the second power cycle between T1 and T2, and in subsequent power cycles so long as the power delivery technique 306 of FIG. 3D is used. By being able to concurrently activate at one time both a radiant heater and a dryer using the power delivery technique 306, the radiant heaters 208 and the dryers 210 can rapidly increase their heat output by use of the power delivery technique 306.

After the initialization phase of the heaters, a different power delivery technique can be used, including a selected one of the power delivery techniques 300, 302, and 304 of FIGS. 3A, 3B, and 3C, respectively.

The power delivery technique 304 of FIG. 3C allows for simultaneous activation of the dryers within a power cycle (such as depicted by blocks 316 and 318 during a portion 323-1 of the first power cycle or by blocks 320 and 322 during a portion 323-2 of the second cycle in FIG. 3C). Moreover, with the power delivery technique 304, in another portion 324-1 or 324-2 of each of the first and second power cycles, the first radiant heater and the first dryer can be simultaneously active in a first half of the cycle portion 324-1 (as depicted by blocks 326 and 325), and in a second half of the cycle portion 324-1, the second radiant heater and the second dryer can be activated simultaneously (as depicted by blocks 330 and 328).

By allowing the two dryers to be activated concurrently with each other during the cycle portion 323-1 or 323-2 of each power cycle, and allowing a dryer to be activated concurrently with a radiant heater during each respective part of the cycle portion 324-1 or 324-2 of each power cycle, the power delivery technique 304 of FIG. 3C can be used in those scenarios where a power request for the radiant heaters 208 is low enough that more power can be supplied to the dryers 210 to satisfy the power request for the dryers 210. A blank portion 331 in the second power cycle represents a condition where none of the radiant heaters 208 and the dryers 210 are activated.

In some examples, the power delivery technique 306 of FIG. 3D can be considered a special case of the power delivery technique 304 of FIG. 3C. With the power delivery technique 306 of FIG. 3D, all available power is consumed for two consecutive power cycles, to supply power to the radiant heaters and the dryers for the initialization phase, such as from a cold start.

With the different power delivery technique 302 of FIG. 3B, within each power cycle, the first and second dryers can be simultaneously activated in a portion 336-1 or 336-2 of the power cycle (similar to the power delivery technique 304 of FIG. 3C). However, with the power delivery technique 302 of FIG. 3B, simultaneous activation of a dryer and a radiant heater is not allowed (as depicted in cycle portion 338-1 or 338-2 of FIG. 3C). For example, in a first half of the cycle portion 338-1 or 338-2, the first radiant heater is activated (as indicated by a block 332), but no dryer is activated during this first half of the cycle portion 338-1 or 338-2. In a second half of the cycle portion 338-1 or 338-2, the second radiant heater can be activated (as indicated by the block 334), but a dryer is not simultaneously active during the second half of the cycle portion 338-1 or 338-2.

Note that the power delivery technique 302 of FIG. 3B supplies less power to the dryers 210 than the power delivery technique 304 of FIG. 3C, since simultaneous activation of a dryer with a radian heater is not permitted in each power cycle.

Another power delivery technique, 300 of FIG. 3A, does not allow for simultaneous activation of multiple heaters at any time. In other words, at any given time within a power cycle, just one of the radiant heaters 208 or dryers 210 are activated at one time.

Among the power delivery techniques 300, 302, and 304, the power delivery technique 300 consumes the least amount of power, the power delivery technique 302 consumes an amount of power that is greater than that consumed by the first power delivery technique 300, and the power delivery technique 304 consumes an amount of power that is greater than the amount of power consumed by the power delivery technique 302.

In response to power requests for the radiant heaters 208 and the dryers 210, the power delivery controller 220 selects the power delivery technique (from among the power delivery techniques 300, 302, and 304) that uses the lowest amount of power that can still satisfy the power request for the dryers given the power consumption for the radiant heaters 208.

As an example, if the power request for the radiant heaters 208 together specifies a PWM duty cycle of 40%, then the power delivery technique 300 (FIG. 3A) can provide up to a PWM duty cycle of up to 30% for the dryers 210 (60%*500 W/1000 W, where 60% is the available PWM duty cycle given the PWM duty cycle requested for the radiant heaters, 500 W is the power consumption of a dryer, and 500 W/1000 W reflects the fact that the power delivery technique 300 does not allow simultaneous activation of dryers).

If the power request for the radiant heaters 208 together specifies a PWM duty cycle of 40%, the second power delivery technique 302 (FIG. 3B) can provide a PWM duty cycle of up to 60% to the dryers 210 (60%*1000 W/1000 W, where 1000 W/1000 W reflects the fact that the power delivery technique 302 allows simultaneous activation of dryers).

If the power request for the radiant heaters 208 together specifies a PWM duty cycle of 40%, the third power delivery technique 304 (FIG. 3C) can provide a PWM duty cycle up to 80% to the dryers 210 (60%*1000 W/1000 W+40%*500 W/1000 W, where 40%*500 W/1000 W reflects the fact that the power delivery technique 304 allows simultaneous activation of a dryer with a radiant heater in the cycle portion 324-1 or 324-2 as shown in FIG. 3C).

Thus, in an example, with the radiant heaters together specifying a PWM duty cycle of 40%, if the dryer power request (e.g., 230 in FIG. 2) specifies a PWM duty cycle 25%, then the power delivery controller 220 can select the power delivery technique 300, which is the power delivery technique that uses the lowest amount of power that can still satisfy the power request for the dryers given the power consumption for the radiant heaters 208). On the other hand, if the dryer power request 230 specifies a PWM duty cycle of 75%, then the power delivery technique 304 is selected.

Further, with the radiant heaters together specifying a PWM duty cycle of 40%, if the dryer power request 230 specifies a PWM duty cycle of 85%, the power delivery technique 304 is selected. Note, however, that even though the maximum amount of power can be provided to the dryers 210 using the power delivery technique 304, the dryers 210 will not actually receive the power requested, since the power delivery technique 304 can provide up to a PWM duty cycle of 80% to the dryers 210, which is less than the 85% requested. Even though a temperature sag may occur with the dryers 210 in this scenario, it is noted that such a scenario is abnormal and should not occur frequently.

The following sets forth program code that implements the logic of the power delivery controller 220, according to some examples.
1 SUM_OF_RADIANT_PWM=RADIANT_1_PWM+RADIANT_2_PWM;
2 BUCKET1_MAX_PWM=(1−SUM_OF_RADIANT_PWM)/2;
3 BUCKET2_MAX_PWM=1−(SUM_OF_RADIANT_PWM);
4 BUCKET3_MAX_PWM=1−(SUM_OF_RADIANT_PWM/2)
5 If (DRYER_PWM BUCKET1_MAX_PWM), SELECT BUCKET1;
6 Else if (DRYER_PWM≤BUCKET2_MAX_PWM), SELECT BUCKET2;
7 Else SELECT BUCKET3.

At line 1 of the program code above, SUM_OF_RADIANT_PWM is the sum of RADIANT_1_PWM (which represents the PWM duty cycle requested for the first radiant heater) and RADIANT_2_PWM (which represents the PWM duty cycle requested for the second radiant heater). The value of SUM_OF_RADIANT_PWM represents the total PWM duty cycle requested for the radiant heaters 208.

Line 2 of the program code above calculates the maximum PWM duty cycle available for the dryers 210 for the power delivery technique 300 (referred to as BUCKET1), and line 3 of the program code above calculates the maximum PWM duty cycle available for the dryers 210 for the power delivery technique 302 (referred to as BUCKET2), given the value of SUM_OF_RADIANT_PWM. At lines 2 and 3, MAX_PWM represents the maximum PWM duty cycle that can be provided. Line 4 of the program code above calculates the maximum PWM duty cycle available for the dryers 210 for the power delivery technique 304 (referred to as BUCKET3), given the value of SUM_OF_RADIANT_PWM.

Line 5 of the program code above specifies that if the PWM duty cycle requested for the dryers 210 (DRYER_PWM) is less than or equal to BUCKET1_MAX_PWM, then the power delivery technique 300 (BUCKET1) is selected. Line 6 specifies that if DRYER_PWM is greater than BUCKET1_MAX_PWM but less than or equal to BUCKET2_MAX_PWM, then the power delivery technique 302 (referred to as BUCKET2) is selected.

Line 7 specifies that if DRYER_PWM is greater than BUCKET2_MAX_PWM, then the power delivery technique 304 (referred to as BUCKET3) is selected.

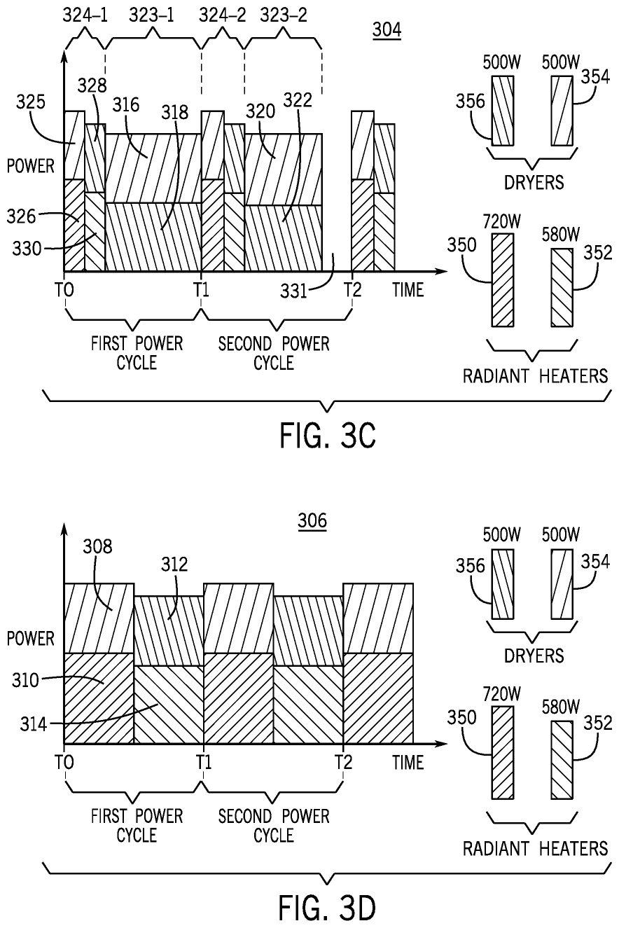

FIG. 4 is a block diagram of a non-transitory machine-readable or computer-readable storage medium 400 storing machine-readable instructions that upon execution cause a system comprising a first type heater and a second type heater to perform various tasks. The machine-readable instructions include power request receiving instructions 402 to receive a power request indicating a power level for the second type heater. The machine-readable instructions further include instructions 404, 406, and 408 that are performed in response to the power request. The instructions 404 include available power determining instructions to determine, within a power cycle, an available power based on a determined power consumption of the first type heater.

The instructions 406 include power delivery technique selecting instructions to select a power delivery technique from among different power delivery techniques that employ different ways of delivering power to the first type heater and the second type heater within the power cycle, the selecting of the power delivery technique from among the different power delivery techniques responsive to a determination, based on the determined power consumption of the first type heater, of which of the power delivery techniques are able to supply the power level indicated by the power request for the second type heater.

The instructions 408 include power causing instructions to cause powering of the first type heater and the second type heater using the selected power delivery technique.

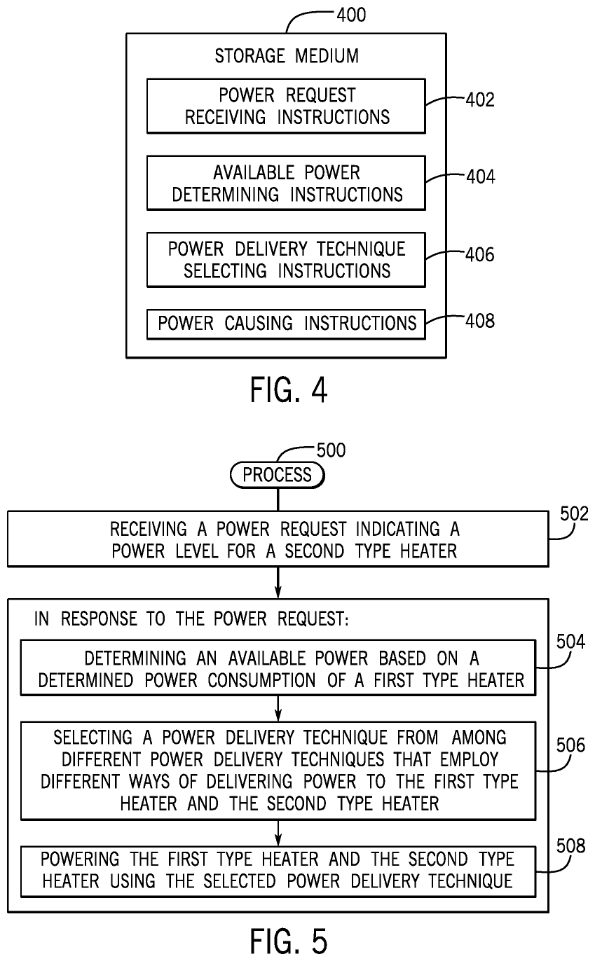

FIG. 5 is a flow diagram of a process 500 performed by a system, such as by a controller (e.g., 106 of FIG. 1 or 220 of FIG. 2) in the system.

The process 500 includes receiving (at 502) a power request indicating a power level for a second type heater.

In response to the power request, the process 500 includes determining (at 504) an available power based on a determined power consumption of a first type heater, selecting (at 506) a power delivery technique from among different power delivery techniques that employ different ways of delivering power to the first type heater and the second type heater, and powering (at 508) the first type heater and the second type heater using the selected power delivery technique.

The storage medium 400 of FIG. 4 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
a first heater and a second heater;
a controller to:
receive a power request indicating a power level for the second heater;
in response to the power request, select a power delivery technique from among different power delivery techniques that employ different ways of delivering power to the first and second heaters, wherein to select the power delivery technique from among the different power delivery techniques is based on a determination of which of the power delivery techniques are able to supply the power level indicated by the power request for the second heater; and
cause powering of the first and second heaters using the selected power delivery technique.

2. The system of claim 1, further comprising an additional heater, wherein the power delivery techniques employ different ways of delivering power to the first heater, the second heater, and the additional heater.

3. The system of claim 1, wherein the controller is to determine if a first power delivery technique of the different power delivery techniques is able to supply the power level indicated by the power request for the second heater based on a power level to be used by the first heater.

4. The system of claim 3, wherein the controller is to determine, within a cycle, an available deliverable power by the first power delivery technique based on subtracting the power level to be used by the first heater from a maximum deliverable power to heaters, and wherein the controller is to determine if the first power delivery technique is able to supply the power level indicated by the power request for the second heater based on the available deliverable power.

5. The system of claim 4, further comprising a third heater, wherein the controller is to determine, within the cycle, the available deliverable power by the first power delivery technique based on subtracting the power level to be used by the first heater and a power level to be used by the third heater from the maximum deliverable power.

6. The system of claim 1, wherein the controller is to assign a higher priority to the first heater for power delivery than the second heater.

7. The system of claim 1, wherein the first heater is of a first type, and the second heater is of a second type different from the first type.

8. The system of claim 7, wherein the different power delivery techniques comprise:
a first power delivery technique that allows simultaneous activation of the first heater of the first type and the second heater of the second type; and
a second power delivery technique that disallows simultaneous activation of the first heater of the first type and the second heater of the second type.

9. The system of claim 8, comprising multiple heaters of the second type, and wherein the second power delivery technique allows simultaneous activation of the multiple heaters of the second type.

10. The system of claim 9, wherein the different power delivery techniques comprise:
a third delivery technique that disallows simultaneous activation of the multiple heaters of the second type.

11. The system of claim 1, wherein the power request indicating the power level for the second heater indicates a pulse width modulation duty cycle.

12. A non-transitory machine-readable storage medium storing instructions that upon execution cause a system comprising a first type heater and a second type heater to:
receive a power request indicating a power level for the second type heater; and
in response to the power request:
determine, within a power cycle, an available power based on a determined power consumption of the first type heater;
select a power delivery technique from among different power delivery techniques that employ different ways of delivering power to the first type heater and the second type heater within the power cycle, wherein to select the power delivery technique from among the different power delivery techniques is responsive to a determination, based on the determined power consumption of the first type heater, of which of the power delivery techniques are able to supply the power level indicated by the power request for the second type heater; and
cause powering of the first type heater and the second type heater using the selected power delivery technique.

13. The non-transitory machine-readable storage medium of claim 12, wherein the different power delivery techniques comprise two or more selected from among:
a first power delivery technique that allows simultaneous activation of the first type heater and the second type heater;
a second power delivery technique that disallows simultaneous activation of the first type heater and the second type heater, but allows simultaneous activation of multiple second type heaters; and
a third delivery technique that disallows simultaneous activation of the multiple second type heaters.

14. A method performed by a system comprising a first type heater and a second type heater, comprising:
receiving a power request indicating a power level for the second type heater; and
in response to the power request:
determining an available power based on a determined power consumption of the first type heater;
selecting a power delivery technique from among different power delivery techniques that employ different ways of delivering power to the first type heater and the second type heater, the selecting of the power delivery technique from among the different power delivery techniques responsive to a determination, based on the determined power consumption of the first type heater, of which of the power delivery techniques are able to supply the power level indicated by the power request for the second type heater; and
powering the first type heater and the second type heater using the selected power delivery technique.

15. The method of claim 14, further comprising determining, within a cycle, an available deliverable power by the selected power delivery technique based on subtracting the determined power consumption of the first type heater from a maximum deliverable power to heaters,
wherein the determination of which of the different power delivery techniques is able to supply the power level indicated by the power request for the second type heater is based on the available deliverable power, and
if multiple power delivery techniques of the different power delivery techniques are able to supply the power level indicated by the power request for the second heater, the selecting comprises selecting the power delivery technique from among the multiple power delivery techniques that uses a lowest amount of power that can still satisfy the power request for the second heater.
